(19) United States
(12) Patent Application Publication
(10) Pub. No.: US 2009/0026796 A1
(43) Pub. Date: Jan. 29, 2009

(54) Wind Protection System For Convertibles

(75) Inventors: Martin Gruenbaum, Sindelfingen (DE); Dieter Lange, Magstadt (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/793,149

(22) PCT Filed: Dec. 1, 2005
(86) PCT No.: PCT/EP2005/012827

§ 371 Date: Aug. 18, 2008

(30) Foreign Application Priority Data
Dec. 18, 2004 (DE) 10 2004 061 036.3

(51) Int. Cl. B60J 7/22

(52) U.S. Cl. 296/180.1

(57) ABSTRACT

A wind protection system for a convertible vehicle comprises a textured perforated plate which is embossed with a regular honeycomb structure and has a sufficient degree of inherent rigidity so as not to require a frame. In addition, the perforated plate preferably has the greatest possible number of holes of identical shape and size which afford good transparency is achieved.

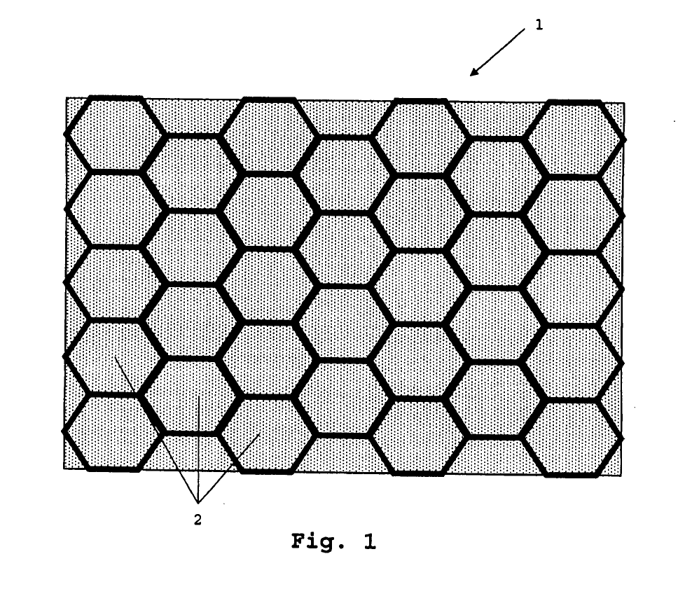

This application is a national stage of PCT International Application No. PCT/EP2005/012827, filed Dec. 1, 2005, which claims priority under 35 U.S.C. § 119 to German Patent Application No. 10 2004 061 036.3 filed Dec. 18, 2004, the disclosure of which is expressly incorporated by reference herein.

### BACKGROUND AND SUMMARY OF THE INVENTION

The invention relates to a wind protection system for convertible vehicles.

A generally known problem in convertibles is that, when the folding top is open, unpleasant drafts occur due to air vortices. Annoyance due to drafts is particularly high especially on the rear seats of the vehicle. In order to avoid a vortex which forms behind a windshield and passes through a passenger compartment, it is known to arrange a wind deflector behind a first row of seats or, in the case of two rows of seats, behind the rear seats, to reduce the annoyance due to drafts when the folding top of the vehicle top is open.

For example, German patent document DE 37 38 500 A1 discloses a transparent protective wall for a convertible, which is arranged behind the front seat backs and protects the front seat region against flow approaching from the rear side due to turbulence caused by the relative wind. The protective wall comprises a plurality of self-supporting surface components made of Plexiglas which are connected to one another in the manner of a film hinge.

Furthermore, German patent document DE 38 44 844 C3 discloses a wind protection system for cabriolets, which comprises two parts which are connected to each other by means of hinges and are each formed by a flexible net stretched in a frame. The net has a degree of elasticity which evens out an air flow impinging from the rear, and reduces turbulence and air velocity so that a low flow noise level, without annoying pulsation, is perceived in the interior of the vehicle.

German patent document DE 195 34 584 C1 discloses a wind protection system for a convertible vehicle, with a fixed roll bar which is composed of a central part and two side parts. In this case, the central part is formed by a transparent plastic screen arranged vertically while the side parts are formed by injection-molded plastic grates or perforated plates provided with a frame.

German patent document DE 41 19 530 A1 discloses a wind protection system for convertibles, which comprises at least one transparent screen with a multiplicity of perforations that can differ in size. The screen keeps a large part of the air flow coming from the rear of the vehicle away from the passengers. A small desired part of this air flows through the apertures.

Finally, German patent document DE 43 35 103 C1 discloses a wind protection system for vehicles, in particular convertibles, with a covering wall that has air passage openings and is made from a sheet-metal part or expanded metal and a frame on the circumference or circumferential region. The air passage openings are optimized and oriented so that they are as few in number as possible. However, this wind protection system requires a correspondingly large thickness or the frame in order to obtain the required rigidity. In addition, vision is significantly impaired.

Conventional wind protection systems are not particularly suitable for use in four-seat convertibles, since they become soiled too rapidly and/or cannot be sufficiently tensioned. Therefore disadvantageous acoustic effects arise.

Accordingly, one object of the present invention is to provide a wind protection system of the type described above which requires neither a great thickness nor a frame.

Another object of the invention is to provide such a wind protection system in which vision is not impaired.

Still another object of the invention is to provide such a wind protection system which is suitable for use in a four-seat convertible without a high degree of soiling and/or with an easy cleaning option.

These and other objects and advantages are achieved by the wind protection system according to the invention, which is formed from a (convexly) textured perforated plate. As a result, it has a sufficient degree of inherent rigidity, and therefore, despite a small thickness, a frame is not required. It also has a very large number of holes, which do not require any particular configuration and by means of which a very good view through is made possible. In addition, because of the use of a perforated plate, the degree of soiling is only slight and/or cleaning is easily possible.

Other objects, advantages and novel features of the present invention will become apparent from the following detailed description of the invention when considered in conjunction with the accompanying drawings.

### BRIEF DESCRIPTION OF THE DRAWINGS

The single FIGURE is a schematic illustration of a partial region of an exemplary embodiment of a wind protection system according to the invention, comprising a textured perforated plate.

### DETAILED DESCRIPTION OF THE INVENTION

A wind protection system is required for both two-seat and four-seat convertibles or similar vehicles in order to reduce significantly air vortices in the interior of the vehicle due to air flows from the rear to the front. A wind protection system of this type is generally fitted directly behind the seats, in the case of two-seat convertibles, and behind the rear seats, in the case of four-seat convertibles. However, other arrangements are also conceivable as long as they obtain the purpose of significantly reducing air vortices in the vehicle interior.

The wind protection system according to the invention comprises a textured perforated plate which, on account of its texturing in the form of a honeycomb structure (i.e., comprising hexagons), does not require a frame in order to be able to offer a sufficient degree of rigidity to wind pressure and to avoid any disadvantageous acoustic effects. The greatest possible number of holes is formed in this textured perforated plate, thus giving rise to the best possible view through without impairing the effect of the wind protection system. The holes are preferably simple circular holes of identical size; formation of different holes or restriction of the number of holes is not required, but, of course, is always possible.

The FIGURE is a schematic illustration of a partial region of an exemplary embodiment of a wind protection system according to the invention comprising a textured perforated plate.

As is apparent from the FIGURE, the perforated plate 1 according to the invention has, for example, a honeycomb structure made of hexagons 2 (or modified hexagons slightly deviating therefrom), which are formed, for example, by means of embossing and by means of which the perforated plate is stiffened. The perforated plate may be made of metal, such as, for example, steel, aluminum or magnesium; or alternatively it can be formed from plastics, such as polymers, fiber-reinforced plastics, etc., or sandwich constructions made from plastic-metal composites.

Alternative configurations of the performated plate 1, which can be formed by means of embossing or, alternatively beading, are cups, rectangles, polyhedrons, etc., which provide good inherent rigidity. The perforated plate 1 preferably has the greatest possible number of holes of identical shape and size. Nevertheless, an embodiment with fewer holes, or holes of different shape, is also conceivable, as long as the textured perforated plate 1 ensures that a satisfactory degree of transparency is guaranteed and air vortices are reliably prevented in the interior of the vehicle.

The preferred configuration is a regular honeycomb structure of hexagons. Despite the good inherent rigidity of the textured perforated plate, easy machining is possible if a small width across the honeycombs is used.

In the case of each of the structures, it is possible to coat (for example by means of band painting, anodizing) and to paint the wind protection system according to the invention either prior to the texturing operation and only then to texture it, or to coat it directly after a texturing operation.

Of course, the textured perforated plate according to the invention can also be used in four-seat convertibles. Then, due to the multiplicity of holes, only a small degree of soiling occurs, and if cleaning is required it can be easily carried out. Due to the inherent rigidity of the textured perforated plate according to the invention, an arrangement of the wind protection system is now possible not just at conventional locations used in the convertible, but also use can be made of heretofore unconventional locations which are better suited in terms of flow for the wind protection system to be effective, but were previously technically not possible.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-13. (canceled)

14. A wind protection system for a vehicle having a roof member that can be opened, said wind protection system comprising:
a partition provided with air passage openings therein; wherein:
the partition is textured;
the partition has a frameless configuration and comprises a perforated-plate-like structure; and
texturing of the partition is convex.

15. The wind protection system as claimed in claim 14, wherein the texturing is a regular honeycomb structure.

16. The wind protection system as claimed in claim 14, wherein the texturing of the perforated-plate-like structure is formed by embossing.

17. The wind protection system as claimed in claim 14, wherein the texturing of the perforated-plate-like structure is formed by beading.

18. The wind protection system as claimed in claim 15, wherein the texturing of the perforated plate-like structure comprises one of cups, rectangles and polyhedrons.

19. The wind protection system as claimed in claim 15, wherein the texturing of the perforated-sheet-like structure comprises a honeycomb structure of regular hexagons.

20. The wind protection system as claimed in claim 15, wherein the texturing of the perforated-sheet-like structure comprises a honeycomb structure of modified hexagons.

21. The wind protection system as claimed in claim 14, wherein the perforated-plate-like structure is made of at least one of steel, aluminum and magnesium.

22. The wind protection system as claimed in claim 14, wherein the perforated-plate-like structure is made from one of plastics, fiber-reinforced plastics, and a sandwich construction made of plastic-metal composites.

23. The wind protection system as claimed in claim 14, wherein the visible surface of the partition is painted and is matched in appearance to one of the surface and interior fittings of the vehicle.

24. The wind protection system as claimed in claim 14, wherein the greatest possible number of air passage openings is formed.

25. The wind protection system as claimed in claim 14, wherein the air passage openings have the same shape and size.

26. The wind protection system as claimed in claim 14, wherein the partition is arranged behind one of front seats and shaped seats of the vehicle.

27. A wind protection system for a convertible vehicle, comprising:
a frameless partition having air passage openings therein; wherein
the partition is formed by a textured sheet of material; and
the sheet of material is embossed to form a convexly textured perforated plate structure according to a pattern of geometric shapes.

28. The wind protection system according to claim 27, wherein said pattern comprises a matrix of contiguous convex pattern portions formed in said sheet of material.

29. The wind protection system according to claim 28, wherein said convex pattern portions comprise one of cup shaped portions, rectangular portions and polyhedron portions.

30. The wind protection system according to claim 27, wherein texturing of said perforated plate structure is formed by one of embossing and beading.
